(19) United States
(12) Patent Application Publication
(10) Pub. No.: US 2009/0192930 A1
(43) Pub. Date: Jul. 30, 2009

(54) METHODS AND SYSTEMS FOR TRADING OPTIONS AND OTHER DERIVATIVES

(76) Inventor: Michael Breitenbach, New York, NY (US)

Correspondence Address: DEAN P. ALDERUCCI, CANTOR FITZGERALD, L.P., 110 EAST 59TH STREET (6TH FLOOR), NEW YORK, NY, 10022, US

(21) Appl. No.: 12/197,734

(22) Filed: Aug. 25, 2008

Related U.S. Application Data
(60) Provisional application No. 60/957,969, filed on Aug. 24, 2007.

(51) Int. Cl. G06Q 40/00

(52) U.S. Cl. 705/37; 705/35

(57) ABSTRACT

In at least one aspect of the invention, systems are provided that comprise at least one computing device coupled to a plurality of other computing devices that are operable to retrieve market data for a plurality of risk reversals for a currency pair, determine a currency in which to quote skew for each of the risk reversals at a first time, determine that there has been a change in skew, and cause an interface screen to be displayed at least one of the other computing devices with a listing comprising the first and second risk reversals, the market data, and an indication of the change in skew of the at least one of the risk reversals.

The present application claims priority to U.S. Provisional Patent Application No. 60/957,969, filed Aug. 24, 2007, which is hereby incorporated herein by reference.

### BACKGROUND

The present application generally relates to trading systems and more particularly interfaces for displaying trading and trading related information.

### SUMMARY OF THE INVENTION

In at least one aspect of the invention, systems and corresponding methods are provided that comprise at least one computing device coupled to a plurality of other computing devices. The at least one computing device operable at least to retrieve market data for a plurality of risk reversals for a currency pair at a first time, at least one of the risk reversals having a first maturity and at least a second risk reversal having a second maturity different than the first; determine a currency in which to quote skew for each of the risk reversals; communicate to and therewith causing an interface screen to be displayed at least one of the other computing devices a listing comprising the first and second risk reversals, the market data, and an indication of the determined skew for each of the risk reversals; retrieve market data for at least one of the first and second risk reversals at a later time; determine that there has been a change in skew, based on the later retrieved market data, of the at least one of the first and second risk reversals; and communicate to and therewith refresh the interface screen displayed at the at least one other computing device the later retrieved market data and an indication of the change in skew of the at least one of the first and second risk reversals.

In at least one embodiment, the market data comprises price or volatility, and size data for each of the risk reversals.

In at least one embodiment, the risk reversals are arranged by maturity in a column layout.

In at least one embodiment, skew is quoted at least initially in units of non-dominant currency of the currency pair.

In at least one embodiment, the indication of skew comprises a currency symbol and an indicator of a type of option being bid and wherein a change in skew is indicated by substituting another currency symbol associated with the currency pair.

In at least one embodiment, the change in skew is further indicated by substituting an indicator associated with another type of option.

In at least one embodiment, the indication of skew further includes displaying a color associated with the type of option being bid and wherein the change in skew is further indicated by substituting the color associated with the another type of option.

In at least one embodiment, the market data displayed comprises buy and sell side quotes for the risk reversals in an orientation, and wherein the change in skew is further indicated by flipping the orientation.

In at least one embodiment, change in skew is determined when, in a left to right orientation, (Left-Hand Rate<0) AND (AbsoluteValue (Left-Hand Rate)<AbsoluteValue(Right-Hand Rate)).

### BRIEF DESCRIPTION OF THE FIGURES

FIG. 1 illustrates a system according to at least one embodiment of the systems disclosed herein;

FIG. 2 illustrates a flow diagram according to at least one embodiment of the methods disclosed herein; and

FIGS. 3-27 illustrate interface screens for use with at least one of the methods and systems disclosed herein.

### DETAILED DESCRIPTION OF THE INVENTION

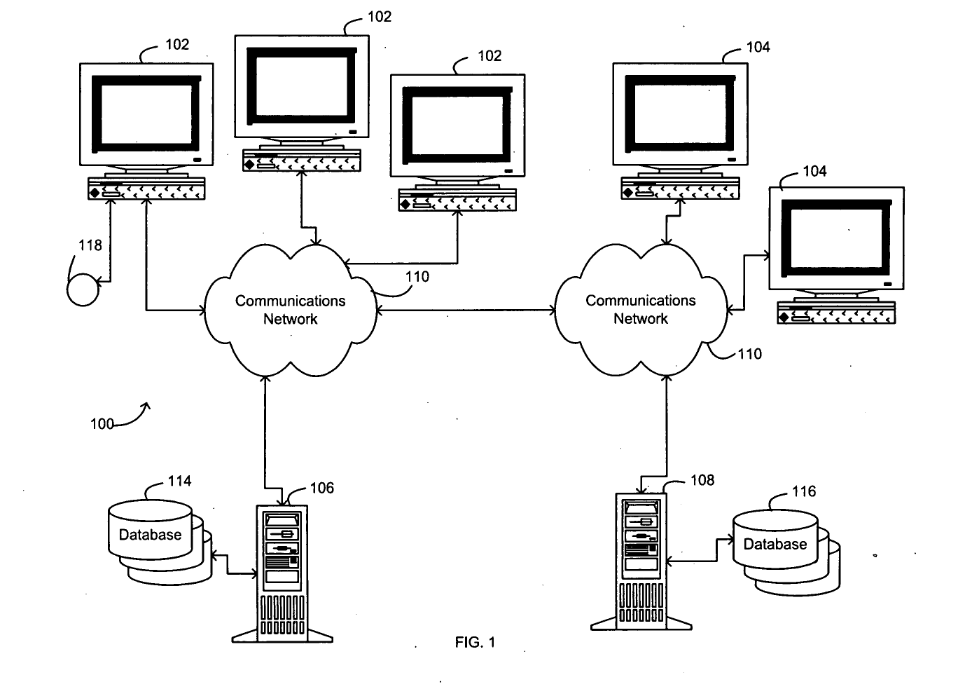

Referring to FIG. 1, a system 100 according to at least one embodiment of the systems disclosed herein includes at least one computing device, such as a remote computer 106, 108, e.g., a server computer, a client computer 102, 104, or a combination thereof. The term remote in this context merely means that the remote computer 106, 108 and at least one of the client computers 102, 104 are separate devices. Thus, the devices may be remote even if they are located within the same room. In at least one embodiment, the system includes at least one internal exchange computer 106 that is connected over a communication network 110 to one or a plurality of internal client computers 102 and at least one external exchange computer 108. The external exchange computer 108 may further be connected to an external client computer 104. One or more of the internal client computers 102 may be connected to the internal exchange computer 106 through a firewall.

The system 100 may be implemented over any type of communications network 110, such as a local area network (LAN), a wide area network (WAN), the Internet, a telephone network (POTS), a wireless network, including cellular, WiFi, and WiMax networks, or a combination of wired and/or wireless networks. In certain instances, the communications network 110 may be independent of the Internet or limited with respect to the type of the information transmitted over the Internet, such as to information that poses little or no security risk if misappropriated or that has been encrypted.

In the networked embodiment, client computers 102 are preferably configured or otherwise capable of transmitting and/or receiving communications to and/or from the computer 106. This may be accomplished with a communication element, such as a modem, an Ethernet interface, a transmitter/receiver, etc., that enables communication with a similarly equipped computer 106, wirelessly, wired, or a combination thereof. It is understood that the relative functionality described herein may be provided by the remote computer 106, by the client computer 102, or both, and is thus not limited to any particular one of the implementations discussed herein. In at least one embodiment, the client computers 102 will generally provide the front-end functionality and the computer 106 will provide the back-end functionality.

Although various embodiments may be described herein in relation to foreign exchange options and risk reversals, it is understood that the methods and systems disclosed herein are equally applicable to other types of financial instruments as well as non-financial instrument items and is thus not limited thereto. The term “financial instrument” denotes any instrument, issued by a corporation, government, or any other entity, that evinces dept or equity, and any derivative thereof, including stocks, bonds, debentures, certificates of interest or deposit, warrants, options, futures, forwards, swaps, or generally any security.

The computing device, e.g., the client computers 102, 104 and/or the remote computers 106, 108, generally include at least one processor, and a memory, such as ROM, RAM, FLASH, etc., or any computer readable medium, such as a hard drive, a flash-drive, an optical or magnetic disk, etc. The memory or computer readable medium preferably includes software stored thereon that when executed performs one or more steps of the methods disclosed herein, including communicating data and commands back and forth between the computers, displaying interface screens, etc. The computers may also be associated with or have access to one or more databases 114, 116 for retrieving and/or storing the various types of data discussed herein, including identity verification data, such as an ID and password, biometric data, etc., trade/order and market data, account data, communication preferences, templates, professed interest, historic data, user preferences, etc.

The client computers 102, 104 may include, without limitation, a mobile phone, PDA, pocket PC, personal computer, as well as any special or other general purpose computing device. As such, the client computer 102, 104 preferably includes a processor, a memory, a display, such as a CRT or an LCD monitor, for displaying information and/or graphics associated with the functionality provided by the system 100, and at least one input device, such as a mouse, a touch-sensitive pad, a pointer, a stylus, a trackball, a button or a plurality of buttons, e.g., alphanumeric, a scroll wheel, a touch-sensitive monitor, etc., or a combination thereof, for users to enter commands and/or information relevant to the system's functionality. With the general purpose type of client computer 102, 104, such as the PC or PDA, users may access the functionality provided by the system 100 with a browser application or any other generic application, or with special purpose software designed specifically for accessing the functionality disclosed herein.

In at least one embodiment, the client computer 102, 104 includes or is otherwise associated with at least one biometric sensor 118. The biometric sensor 118 is any device that is used to determine directly from the user at least one item of biometric data associated with a user, such as a fingerprint reader, an iris scanner, a retinal scanner, a vascular pattern reader, a facial recognition camera, etc. The biometric sensor 118 may be embodied in hardware, software, or a combination thereof. The biometric sensor 118 may further share resources with other components of the client computer 102, 104, such as the processor, memory, a camera, a microphone, a speaker, etc. A single biometric sensor 118 may be used for reading more than one type of biometric data. For example, a digital camera may be used to obtain an image of the user's eye for iris scanning and an image of the user's face for facial recognition. In this instance, a single image capture of the user's face may provide the data for facial recognition as well as data for iris or retinal comparisons.

The biometric data is generally obtained with the biometric sensor 118 and used at least to authenticate the identity of the user as a gateway for allowing the user to access the system's functionality. In this regard, biometric data may be compared with previously obtained/stored biometric data that has preferably been verified as being associated with a particular user and access to the system's functionality may be provided based on a positive match thereof.

In at least one embodiment, the system 100 provides functions relevant to trading financial instruments or other items in one or a plurality of exchanges, such as an over the counter (OTC) exchange, a public exchange, an external (OTC) exchange, an electronic communication network (ECN), etc. An exchange generally includes or otherwise supports at least one or a plurality of markets. In this respect, the system 100 allows users, such as traders, brokers, dealers, customers, market makers, etc., to access market data and submit orders to the one or more exchanges using at least one client computer 102, 104. The term orders as used herein includes actual orders, such as bids, offers, buys, sells, requests for quotes (RFQs), quotes, etc. It is understood that a user may be acting in a principal or agency capacity. Therefore, the acts disclosed herein as being performed by a user, include acts of the principal and acts of the agent. For example, when referring to a user submitting an order, this includes a broker submitting an order for a customer as well as the customer submitting the order on his own behalf.

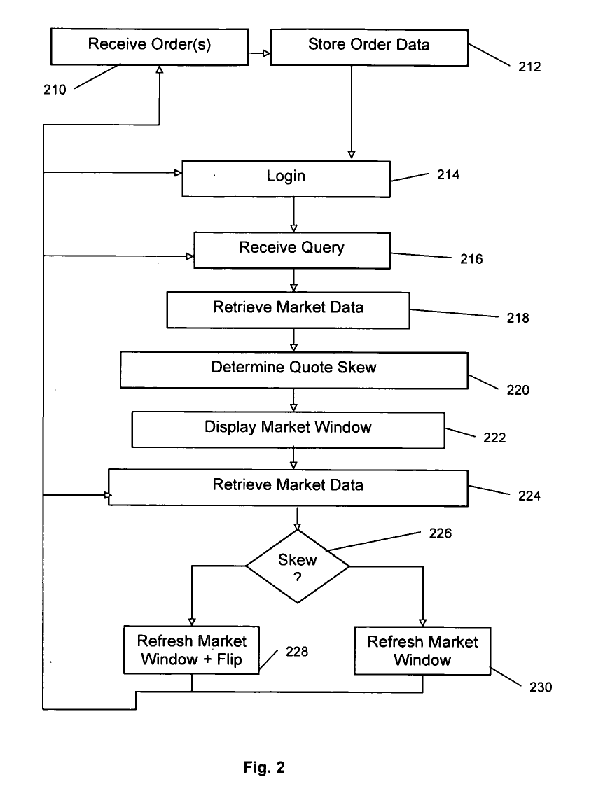

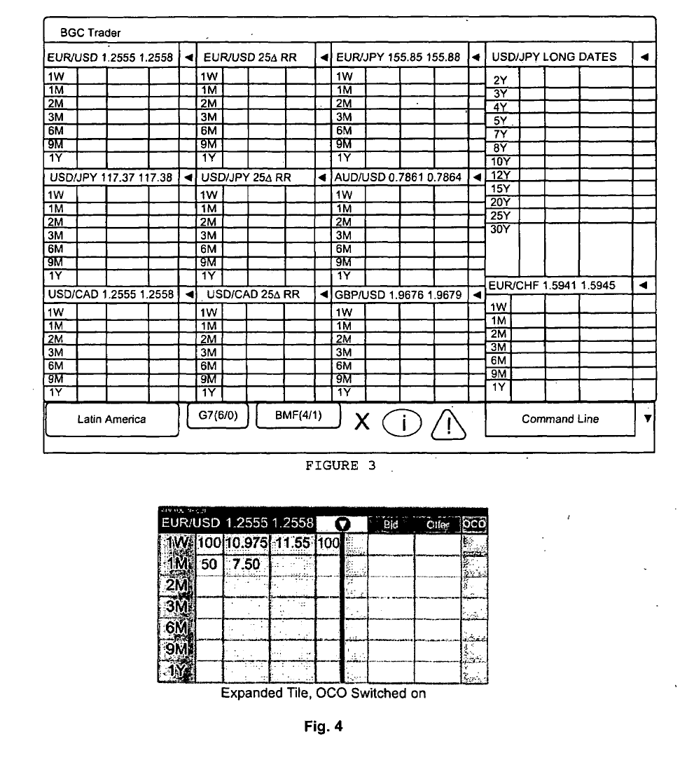

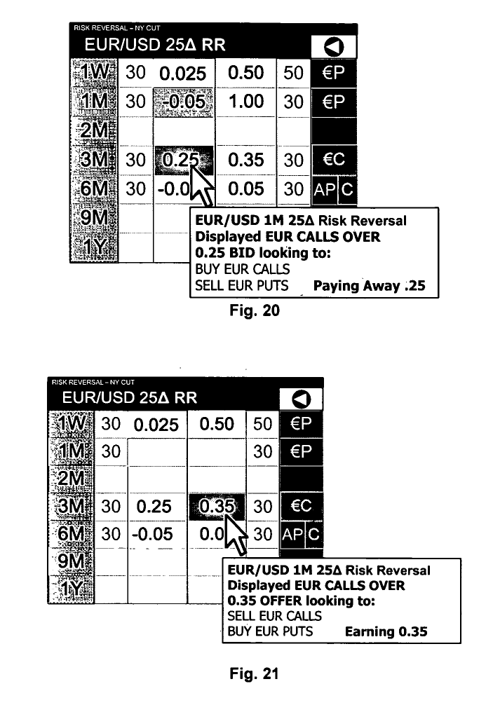

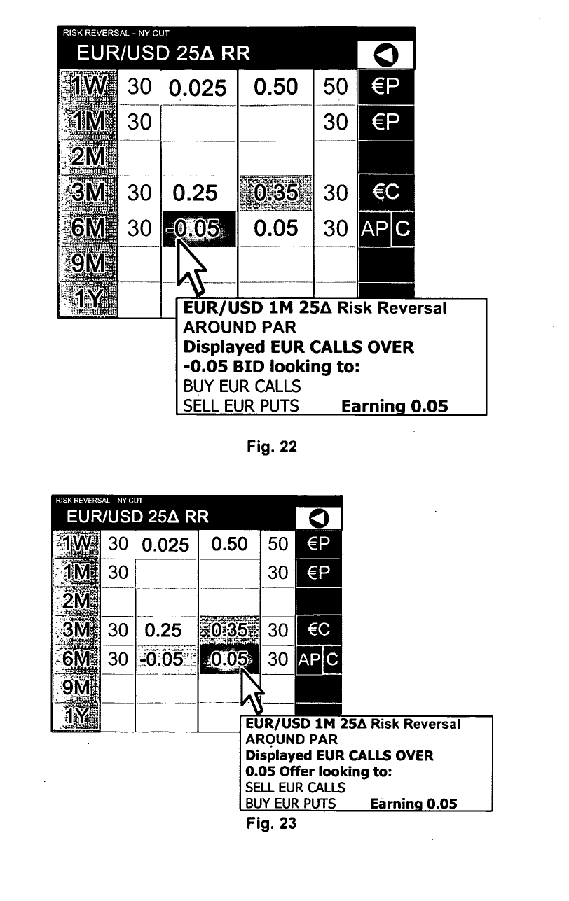

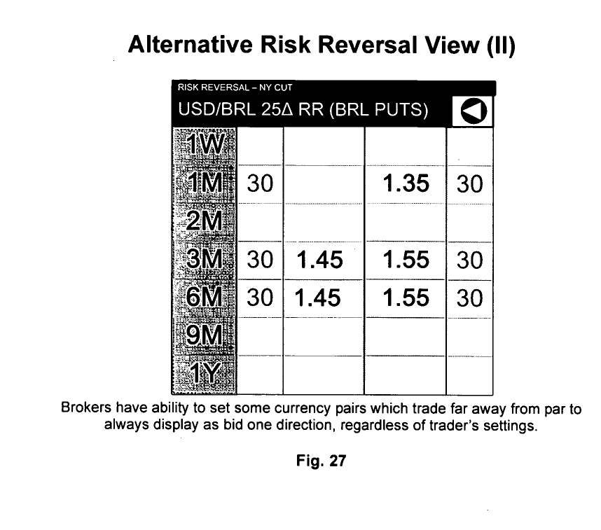

Referring to FIG. 2, in at least one embodiment, the system 100 generally receives orders at 210 and stores the orders at 212 in one or more databases to provide a shared order book. The system 100 may group orders for particular items, e.g., financial instruments, to create a market for each item that includes at least one order for the item. In at least one embodiment, the orders are for derivative instruments, such as options, particularly, foreign exchange (FX) options and/or related instruments, such as FX risk reversals (RRs). Therefore, the system 100 provides a market for at least one FX option and/or at least one FX option risk reversal. The system may also cause an interface screen to be displayed, such as the market display screens/windows shown in FIGS. 3-27, e.g. at the client computer 102, 104, with the relevant market data included therein. The market for each item may be managed or worked by users on a manual, a semi-automatic, or an automated exchange. That is, orders may be executed with the system either automatically and/or manually by the users.

Data from steps 210-212 generally provide at least a portion of the information for populating a market display window. Various types of data may be maintained in this respect, such as the item name and/or symbol, size, price, execution data and/or time, posting date and/or time, buyer/seller name and/or identification number, account numbers, order type, etc., for orders submitted to the system 100, and any data derived therefrom. With regard to FX options and FX RRs, the data maintained may include the currency pair, underlying exchange rates for the currency pair, strike prices, maturity data, bid and offer prices, volatility, delta, bid and offer volumes or sizes, type, e.g., calls, puts, etc., spreads, etc., which may be communicated to users in market display windows for the particular currency pair.

Individual user sessions for access to the relevant functionality of the system 100 may begin with a user logging into the system at 214. That is, a user may login to view or otherwise access market data for one or more items, place one or more orders for the one or more items, etc. Login generally entails receiving identification information from the user, such as a login ID, password, biometric data, etc., and verifying therewith that the user is authorized to access the relevant functionality of the system 100.

In at least one embodiment, the system 100 thereafter retrieves market data for at least one item, e.g., at least one option and/or RR for a currency pair, at 218, and causes an interface screen or window that includes therein the market data retrieved to be displayed at 222. The interface screen or window may be displayed in response to receipt of a query from the user at 218. Options may be quoted in either price or volatility. RRs are typically quoted in volatility. Accordingly, in at least one embodiment, the market data displayed comprises the quote price and/or volatility. The market data may represent actual orders that may be acted on, e.g., with a hit or lift, in which instance, the size of the order or orders may also be displayed.

In causing the interface screen or window to be displayed, the system 100 preferably determines at 220 the currency in which to quote skew for a RR currency pair. In this instance, the interface screen or window may include a label and/or currency label indicating the skew, as shown in FIG. 18. As a matter of market convention, pricing of currency rates for non-dollar currencies vs. the US Dollar are typically quoted in units of the non-dollar currency per US Dollar, with the exception of the British Pound vs. the US Dollar, where the currency rate is quoted in US Dollars per British Pound. Where the US Dollar is not included in the currency pair, the currency rate is typically quoted in units of the non-dominant currency in the pair per the dominant currency, such that the Euro vs. Japanese Yen currency rate may be quoted as number of Japanese Yen per Euro. Similar conventions may be used to quote skew. If a single character currency symbol is available, it may be used (example: ( [symbol] , £C, ¥C, etc). Otherwise, an obvious letter or letters may be chosen (example: USD/CAD->CC and CP).

In one embodiment, if the currency pair includes USD, then the opposite, non-USD currency may be used to quote skew. If the currency pair does not include USD, then the dominant (left-hand) currency may be used instead to quote skew. Examples of quoting of skew between a currency and the US dollar, or between a dominant currency and a non-dominant non-dollar currency, are shown in Table A.

TABLE A

| | | |
|---|---|---|
| USD/JPY | → | JPY |
| EUR/USD | → | EUR |
| EUR/JPY | → | EUR |
| USD/CAD | → | CAD |
| USD/BRL | → | BRL |
| GBP/USD | → | GBP |
| EUR/GBP | → | EUR |
| USD/CHF | → | CHF |
| EUR/CHF | → | EUR |

The market display may also arrange the market data for at least a plurality of options having different maturities in a consistent direction, e.g., from top to bottom, representing shortest duration to longest duration, etc. For example, quotes for 1 W EUR/USD 25 DLT RR may be displayed with the tenors listed from top to bottom representing one week, one month, two months, three months, six months, nine months, and one year (twelve months), and with a left side rate and size and a right side rate and size. The quoting of skew may be accomplished in a single column to the immediate right of the size column for the right side rate. Skew may be displayed for each tenor, with each individual cell displaying skew showing the appropriate currency symbol or identifier followed by a capital “C” to indicate the bidding of calls or a capital “P” to indicate the bidding of puts. The background of the cell in which skew is displayed may further employ a dark red background when the bidding of calls is indicated, and a dark blue background when the bidding of puts is indicated.

As orders are received and trades are executed, the system 100 receives the updated market data at 224. Live bids and offers may be displayed in a bold font. The system 100 may thereafter determine if there has been a change in the skew at 226. If there has been no change in skew, the interface screen or window may be refreshed at 230, real time or otherwise, to include newly retrieved market data. If there has been a change in skew, the interface screen or window may be refreshed, again real time or otherwise, and the indication of skew may be changed to illustrate the reversal of the skew between the currencies in the pair. That is, if the change in skew now favors bidding puts in the non-dollar or dominant currency where previously it had indicated the bidding of calls, the skew indication that formerly displayed the currency symbol followed by a capital “C” against a dark red background changes to showing a display of the currency symbol followed by a capital “P” against a dark blue background. The position and labeling of the currencies may not be changed, but the changes in the best bid and offer rates, and the change from displaying a capital “C” against a dark red background to a capital “P” against a dark blue background, may serve to make transparent and immediate the explicit nature of the change in skew, the indication of which currency is now favored within the currency pair of a risk reversal strategy, and the prices that are bid and offered for the reversed skew condition.

Where no live bids or offers are available at 224 or 226 the rates that are displayed in the rate cells may be presented in a non-bold, light gray font that serves to indicate that the lightly shaded rate is the last valid rate for that tenor and currency but is not a live market. Such lightly shaded last rate indications may be described as “footprints.” The skew for such last valid rate footprints may be presented against a lighter color background to similarly indicate that it is the last valid skew but not a live skew, e.g. with the currency symbol followed by a capital “C” against a light red background where the bidding of calls had been indicated last, or the currency symbol followed by a capital “P” against a light blue background where the bidding of puts had been indicated last. Such lightly shaded rates and lightly shaded backgrounds may serve to may serve to make transparent and immediate that the rates and skew being displayed are the last valid indications but are not live markets.

A risk reversal may be seen as a value spread between two currencies and reflecting the volatility of the value relationship between those currencies. The skew of a risk reversal indicates which of the currencies in the pair is favored, or expected to appreciate relative to the other currency in the pair. In an example where a currency is expected to appreciate over the US Dollar, the skew would favor bidding calls in the non-dollar currency and selling puts in that currency. Should market conditions change such that the US Dollar were then to be expected to appreciate against the non-dollar currency, the skew indicator would change to favoring bidding puts in the non-dollar currency and selling calls in that currency. As a matter of convention, where the US dollar is included in a currency pair, the buying and the selling of options underlying a risk reversal strategy for that currency pair are performed in the non-dollar currency within that pair. Where the US Dollar is not included in a currency pair, the buying and selling of options underlying a risk reversal strategy for that currency pair typically occurs in the dominant currency within that pair. For example, in a Euro vs. US Dollar risk reversal, a change in skew would not result in changing from bidding Euro calls to bidding US Dollar calls, but in changing from bidding Euro calls to bidding Euro puts. Similarly, in a Swiss Franc (CHF) vs. Euro risk reversal, a change in skew would not result in changing from bidding Euro calls to bidding CHF calls, but in changing from bidding Euro calls to bidding Euro puts.

In at least one embodiment, the change in skew is triggered when there is a two sided market for the particular risk reversal tenor and the absolute value of the left hand rate becomes a negative value, less than zero, with an absolute value less than the absolute value of the right hand rate. The market convention is for the left side rate to be displayed as a positive number, i.e. without a negative sign to indicate that it is a negative number, though market participants and analytical programs interpret the rate to be negative.

The condition for the change in skew may be expressed by the following formula:

Left-Hand Rate<0

AND

AbsoluteValue(Left-Hand Rate)<AbsoluteValue(Right-Hand Rate)
1. New Left-Side Rate=−1*(Original Right-Side Rate)
2. New Right-Side Rate=−1*(Original Left-Side Rate)
3. If Original Skew=XP THEN New Skew=XC
4. If Original Skew=XC THEN New Skew=XP (X=appropriate Currency symbol)
5. Last Market Rates for Instrument Flip in Market Cells
6. Scratchpad Rates for Instrument Flip
7. Skew Label Cell for Instruments Flash for several seconds

The change in skew results in a series of changes in the display of the skew for the respective risk reversal tenor for the currency pair. The new left side rate is expressed as a new rate with an absolute value that is lower than the right side rate. The size for the left side rate continues to be displayed to the immediate left of the rate, and the size for the right side rate continues to be displayed to the immediate right of the rate display.

The rightmost column may display the skew for the tenor. The skew may be displayed using both color and symbols to indicate the direction of skew. Continuing with the example of a Euro vs. US Dollar currency pair, where the Euro is expected to appreciate vs. the US dollar, the skew may indicate the buying of Euro calls and the selling of Euro puts, though the display of the Euro symbol (“ [symbol] ”) followed by the letter “C” for calls on a dark red background, to indicate that the skew is positive for the Euro within the Euro/US Dollar currency pair, and that the strategy on the bidding leg is to bid the Euro Call. In the event that the skew flips, reflecting that the Euro is expected to decline with respect to the US dollar, the skew display will change to display the Euro symbol (“ [symbol] ”) followed by the letter “P” for puts on a dark blue background, indicating that the skew is negative for the Euro within the currency pair and that the strategy on the bidding leg now calls for bidding the Euro Put. The skew label will flash for the given instrument for a few seconds.

Additionally, the rates displayed in the market cells for the currencies will flip from the right to the left side, and vice versa, and the scratch pad rates will similarly flip.

The interface screen or window may also include an around par indication in the column for the skew display, as noted in at least one embodiment by a capital “A” for Around Par on, e.g., an orange background on the left side of a cell, followed by a display of the skew in the remaining portion of the cell, e.g., the currency symbol followed by “C” for Call on a dark red or light red background for a live skew or last skew, respectively, or the currency symbol followed by a “P” on a dark blue or light blue background for a live skew or last skew, respectively.

An around par instrument is one in which the absolute value of the two sides of the quote are essentially equal. That is, the left hand rate and the right hand rate are equal in magnitude. The around par indication may require live two way market rates and the around par label or symbol may be combined with the last skew direction symbol without the flip. The steps described herein may be repeated as shown. In certain embodiments the around par indication may be always displayed against an orange background of an unvarying intensity whether it reflected the status of live or last, “footprint” rates.

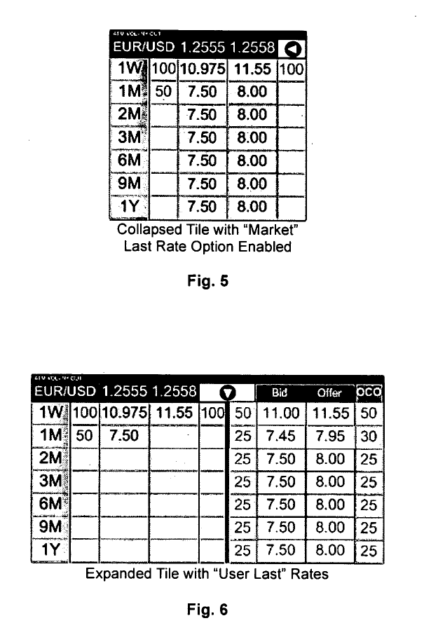

Referring to FIG. 3, an interface screen may be displayed that includes therein one or more market windows. The interface screen may include market windows for a plurality of items, such as FX options and FX RRs, as shown. The individual window for a particular currency pair, such as that shown in FIG. 4, may include two contiguous components displaying, on the left side, current foreign exchange market quotes for the particular currency pair, in this case EUR/USD, and on the right side, risk reversal rates and skew for the currency pair. The window preferably includes quotes disposed therein in cells, e.g., price cells. The window may include two-sided quotes for a plurality of outright foreign exchange tenors for the currency pair, each with different tenors. The quotes may be arranged in a logical order, such as in ascending order of tenor as shown. The quote may include market data, such as the best bid and offer prices or rates, with corresponding sizes. Where live quotes are not available, the last price/rate may be displayed as lighter shaded “footprint” rates as shown in FIG. 5.

In certain embodiments the system may provide for the user to manually change the around par designation or the skew indicator, e.g. to designate a risk reversal for a particular tenor as treading around par, or to change from bidding calls to bidding puts, or from bidding puts to bidding calls.

The window may include an expandable scratch pad for users to specify terms of offers in cells that correspond to the market data cells. The scratch pad may display the user's last rates for the particular options as shown in FIG. 6.

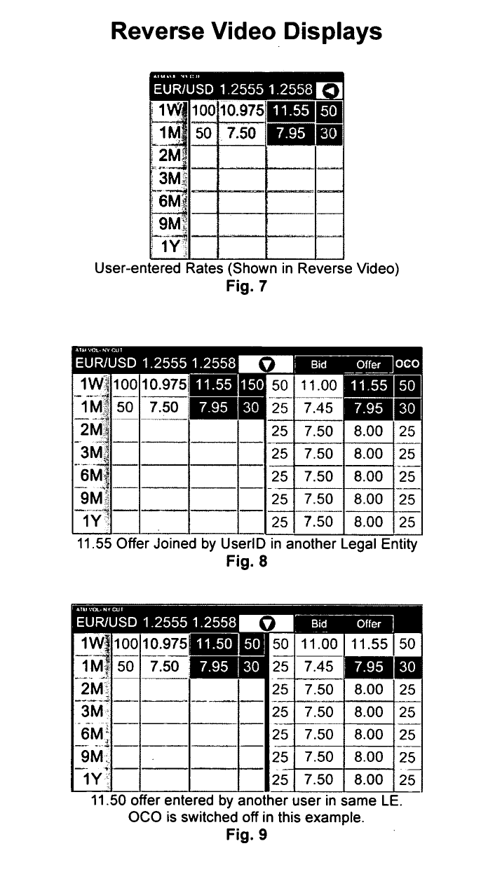

The market window preferably uses highlighting, such as reverse video display of particular cells, to communicate information to the user. For example, highlighting may be used to show the particular user's entered rates/quotes in the market window, as shown in FIG. 7. The quotes may similarly be displayed in the scratch pad, as shown in FIG. 8. Similarly, a first color may indicate that another user has joined the particular user's quote, as also shown in FIG. 8. Another color may be used to indicate that a particular quote originates from an affiliated user, as shown in FIG. 9. Various types of highlighting may be used, such as bolding, underlining, italicizing, coloring, etc. text and/or the cells the data appears in.

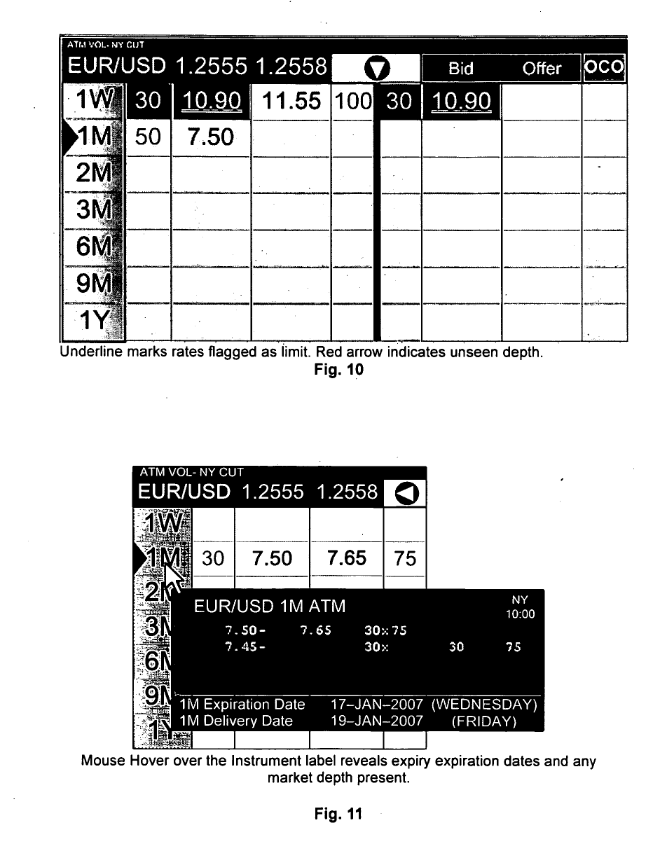

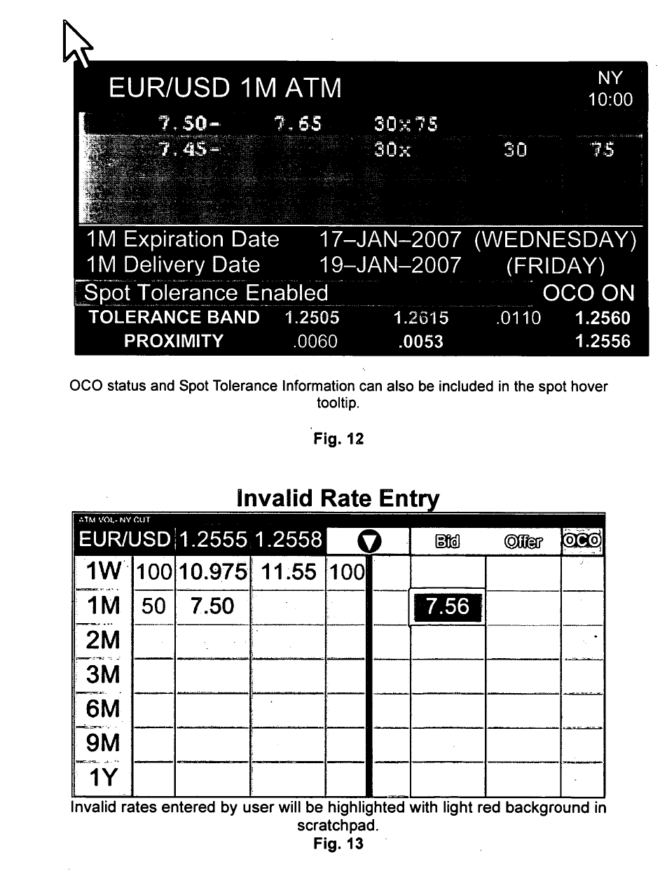

In at least one embodiment, the market window includes a symbol or other indicia to indicate there exists additional market depth beyond the best bid/best offer, as shown in FIGS. 10-12. A mouse over the symbol or the cell or selection of the symbol or the cell may result in a window being displayed that includes therein the additional market depth, as shown in FIG. 11. Other types of information may similarly be displayed, as shown in FIG. 12.

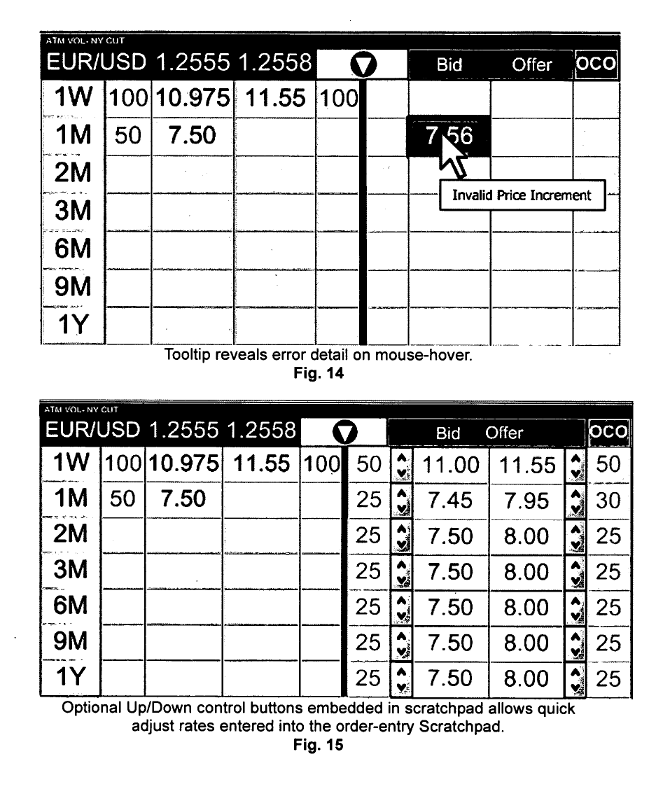

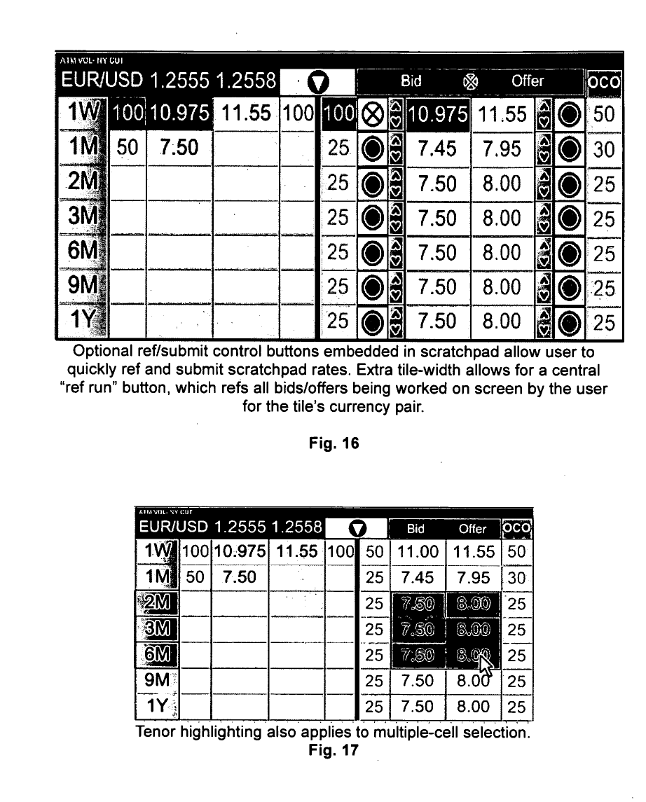

As noted above, the terms of orders may be specified in cells of the scratch pad. In one embodiment, erroneous terms in the cells results in a particular highlighting indicating as such, as shown in FIG. 13. A mouse over the highlighted cell may result in a dialog box with error information therein, as shown in FIG. 14. Order entry may be facilitated with up/down arrows disposed adjacent to the cells in the scratchpad for the user to adjust the rates disposed therein, as show in FIG. 15. The scratch pad may also include a button or other element disposed adjacent to a cell for a user to submit the quote with the selection therewith, as show in FIG. 16. In at least one embodiment, the user is able to select a plurality of cells in the scratch pad, continuous or non-continuous, and submit the quotes in the selected cell in a single action, e.g., with the single selection of a button, a click of the mouse, the use of a keyboard shortcut, or other element.

In at least one embodiment, the scratch pad may be used to submit multiple orders, cancel multiple orders, or change multiple orders by the same increment and then submit, cancel, or delete the multiple orders, as shown in Figure X. The user may select a range in the scratch pad and by hovering the mouse over the selected range, may be presented with the choice to populate the scratch pad cells with either live market rates or last “footprint” rates. The user may subsequently choose, via a mouse click, keyboard shortcut, or other means, to submit the rates as their own order, to “Ref” (delete) the rates, to nudge them up one or two fixed increments and then submit them, to nudge them down one or two fixed increments, or to clear them.

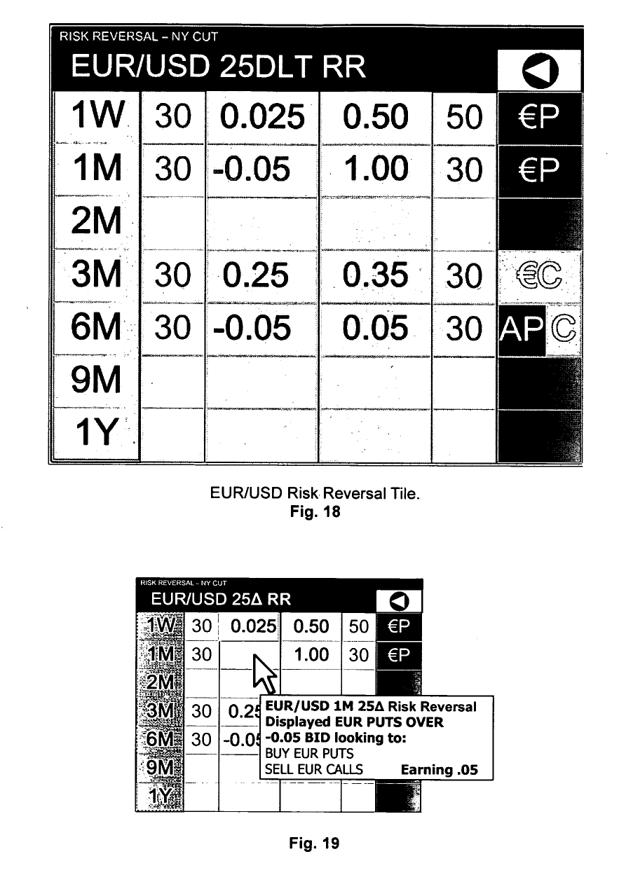

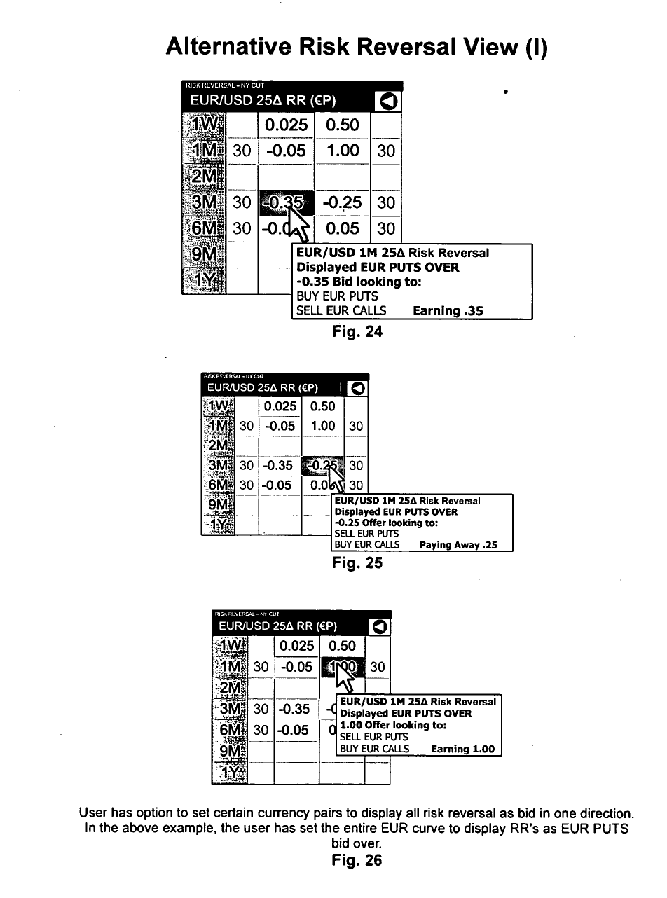

Referring to FIG. 18, an RR market window may similarly include cells that include quotes for a particular RR currency pair. The window may also include quotes for a plurality of RRs with different tenors. As noted above, the quotes for a particular RR are preferably disposed in an order to maintain a consistent low to high arrangement of tenors with an indication of the currency skew and/or if the quotes are around par. Selection of a cell preferably results in a dialog box being displayed with the details of the quoted option, as shown in FIGS. 19-23. Alternatively or in addition, the RR market window may be configured by the user to, e.g., display bids in one direction, as shown in FIGS. 24-27.

In at least one embodiment, the user may have the option to set certain currency pairs to display all risk reversals as bid in a single direction, such that the skew indicator does not flip even when the direction of skew reverses.

In at least one embodiment, the window may have a check symbol in a white circle against a green background, on the top left of the scratch pad, and an “X” symbol on the top right of the scratch pad. Selecting the check symbol on the upper left corner of the scratch pad via mouse click, keyboard shortcut, or other means may submit all the selected rates. Selecting the “X” symbol on the upper right corner of the scratch pad via mouse click, keyboard shortcut, or other means may cancel the submission of the selected rates

While the foregoing invention has been described in some detail for purposes of clarity and understanding, it will be appreciated by one skilled in the art, from a reading of the disclosure that various changes in form and detail can be made without departing from the true scope of the invention.

What is claimed is:

1. A system comprising at least one computing device coupled to a plurality of other computing devices, the at least one computing device operable at least to:
retrieve market data for a plurality of risk reversals for a currency pair at a first time, at least one of the risk reversals having a first maturity and at least a second risk reversal having a second maturity different than the first;
determine a currency in which to quote skew for each of the risk reversals;
communicate to and therewith causing an interface screen to be displayed at least one of the other computing devices a listing comprising the first and second risk reversals, the market data, and an indication of the determined skew for each of the risk reversals;
retrieve market data for at least one of the first and second risk reversals at a later time;
determine that there has been a change in skew, based on the later retrieved market data, of the at least one of the first and second risk reversals; and
communicate to and therewith refresh the interface screen displayed at the at least one other computing device the later retrieved market data and an indication of the change in skew of the at least one of the first and second risk reversals.

2. The system of claim 1, wherein the market data comprises price or volatility, and size data for each of the risk reversals.

3. The system of claim 1, wherein the risk reversals are arranged by maturity in a column layout.

4. The system of claim 1, wherein skew is quoted at least initially in units of non-dominant currency of the currency pair.

5. The system of claim 4, wherein the indication of skew comprises a currency symbol and an indicator of a type of option being bid and wherein a change in skew is indicated by substituting another currency symbol associated with the currency pair.

6. The system of claim 5, wherein the change in skew is further indicated by substituting an indicator associated with another type of option.

7. The system of claim 5, wherein the indication of skew further includes displaying a color associated with the type of option being bid and wherein the change in skew is further indicated by substituting the color associated with the another type of option.

8. The system of claim 5, wherein the market data displayed comprises buy and sell side quotes for the risk reversals in an orientation, and wherein the change in skew is further indicated by flipping the orientation.

9. The system of claim 8, wherein change in skew is determined when, in a left to right orientation, (Left-Hand Rate<0) AND (AbsoluteValue (Left-Hand Rate)<AbsoluteValue(Right-Hand Rate)).

10. A method implemented on a system comprising at least one computing device coupled to a plurality of other computing devices, the method comprising:
retrieving market data for a plurality of risk reversals for a currency pair at a first time, at least one of the risk reversals having a first maturity and at least a second risk reversal having a second maturity different than the first;
determining a currency in which to quote skew for each of the risk reversals;
communicating to and therewith causing an interface screen to be displayed at least one of the other computing devices a listing comprising the first and second risk reversals, the market data, and an indication of the determined skew for each of the risk reversals;
retrieving market data for at least one of the first and second risk reversals at a later time;
determining that there has been a change in skew, based on the later retrieved market data, of the at least one of the first and second risk reversals; and
communicating to and therewith refresh the interface screen displayed at the at least one other computing device the later retrieved market data and an indication of the change in skew of the at least one of the first and second risk reversals.

11. The method of claim 10, wherein the market data comprises price or volatility, and size data for each of the risk reversals.

12. The method of claim 10, wherein the risk reversals are arranged by maturity in a column layout.

13. The method of claim 10, wherein skew is quoted at least initially in units of non-dominant currency of the currency pair.

14. The method of claim 13, wherein the indication of skew comprises a currency symbol and an indicator of a type of option being bid and wherein a change in skew is indicated by substituting another currency symbol associated with the currency pair.

15. The method of claim 14, wherein the change in skew is further indicated by substituting an indicator associated with another type of option.

16. The method of claim 14, wherein the indication of skew further includes displaying a color associated with the type of option being bid and wherein the change in skew is further indicated by substituting the color associated with the another type of option.

17. The method of claim 14, wherein the market data displayed comprises buy and sell side quotes for the risk reversals in an orientation, and wherein the change in skew is further indicated by flipping the orientation.

18. The method of claim 17, wherein change in skew is determined when, in a left to right orientation, (Left-Hand Rate<0) AND (AbsoluteValue (Left-Hand Rate)<AbsoluteValue(Right-Hand Rate)).
